(19) United States
(12) Patent Application Publication
(10) Pub. No.: US 2022/0067539 A1
(43) Pub. Date: Mar. 3, 2022

(54) KNOWLEDGE INDUCTION USING CORPUS EXPANSION

(71) Applicant: INTERNATIONAL BUSINESS MACHINES CORPORATION, Armonk, NY (US)

(72) Inventors: NANDANA MIHINDUKULASOORIYA, Cambridge, MA (US); Md Faisal Mahbub Chowdhury, Woodside, NY (US); Yu Deng, Yorktown Heights, NY (US); Ruchi Mahindru, Elmsford, NY (US); Nicolas Rodolfo Fauceglia, Brooklyn, NY (US); Alfio Massimiliano Gliozzo, Brooklyn, NY (US)

(21) Appl. No.: 17/008,856

(22) Filed: Sep. 1, 2020

(51) Int. Cl. G06N 5/02

(52) U.S. Cl. CPC G06N 5/022

(57) ABSTRACT

A method, a computer program product, and a computer system induce knowledge from a knowledge graph. The method includes receiving a request indicative of a domain. The method includes determining a corpus corresponding to the domain and determining a quality of the corpus in generating the knowledge graph relative to a quality threshold. If the quality threshold is not met, the method includes determining a candidate expansion corpus to incorporate further data therefrom into the corpus relative to an expansion threshold. If the expansion threshold is met, the method includes generating an expanded corpus by expanding the corpus with the further data. The method includes generating the knowledge graph based on the expanded corpus from which the knowledge is induced and generating a response to the request based on the knowledge graph.

### BACKGROUND

The exemplary embodiments relate generally to knowledge graphs, and more particularly to inducing knowledge from available corpora when an original corpus of a knowledge graph requires expansion.

A system may develop a knowledge graph by acquiring and integrating various types of information such as for a specific domain into an ontology such that a reasoner may derive new knowledge or information. The information may be embodied as a corpus of documents or other data in which to develop the knowledge graph. The knowledge graph may model a knowledge domain from different sources in a manual manner or an automated manner such as subject-matter experts, data interlinking, machine learning algorithms, etc. For example, the knowledge graph may be used in providing information from a search query. A user may provide an input into a search field and the search engine may utilize the knowledge graph to ascertain information regarding the search query. In a particular example, when the search query is an individual, the search engine may use the knowledge graph to ascertain personal information, professional information, educational information, etc. and determine which aspects to include in a result of the search query (e.g., based on a threshold of relevance to the search query).

Domain-specific knowledge graphs may either be not publicly available or not reusable in commercial applications for a variety of reasons. For example, as the knowledge graph may be created based on proprietary information, the knowledge graph itself may remain proprietary to the developer of that knowledge graph. Although knowledge graphs may utilize various mechanisms for development, creating the domain-specific knowledge graphs utilizing manual approaches may take a huge effort. For example, manually creating the knowledge graphs may require domain experts who must provide a substantial effort. With regard to a conventional knowledge graph such as the Universal Medical Language System (UMLS), the development of the UMLS took over a decade with contributions from a large number of doctors.

When domain-specific knowledge graphs utilize automated approaches, the knowledge graph may be developed through automatic knowledge induction. However, conventional automatic knowledge induction approaches rely on sufficient and repeated evidences. The evidences may derive from corpora of data. However, some of these corpora lack the evidence on which to induce the information for the knowledge graph. Those skilled in the art will understand that knowledge induction from a corpus may be difficult if the corpus is too small and/or if the corpus is not of a sufficient quality (e.g., the corpus is a chat log). For example, a system may be configured with a knowledge graph based on public troubleshooting documents. However, such a system may utilize a relatively small corpus size (e.g., approximately 4,000 documents occupying 6 MB). Such a corpus size may be relatively small compared to other systems that utilize a much larger corpus size (e.g., another system may use approximately 55,000 documents occupying 75 MB while a further system may use approximately 212,000 documents occupying 768 MB). The corpus being used by the system may also not use fully natural language such as being formatted in lists, commands, logs, etc. Some relevant terms in the corpus for the system may also have very low frequencies where products may appear only once in a single issue. Such a system may not be configured to properly induce knowledge from the knowledge graph.

Conventional approaches for knowledge induction used for knowledge graphs and use of various corpora may utilize a plurality of different mechanisms. However, the conventional approaches often focus on only one aspect of knowledge induction for knowledge graphs and incorporation of corpora without considering the overall process and relative success or relevance of inducing certain knowledge in a meaningful way. For example, U.S. Pat. No. 10,229,188 describes a method to expand a question answer corpus using a quality analysis system where a candidate answer having a rank above pre-specified requirements is added to the corpus. In another example, U.S. Pat. No. 8,892,550 describes improving performance of information retrieval by adding new information like paraphrases that are found in the sources to increase the semantic redundancy through searching for similar content related to existing data, automatically retrieving the content, extracting units of text, and determining their relevance and/or relatedness. However, in these conventional approaches, there is no determination of whether the corpus requires the candidate answer, no identification of a candidate corpus to which the candidate answer is to be added, and no identification of documents in the candidate corpus.

In a further example, U.S. Pat. No. 7,805,288 describes a method for corpus expansion by expanding new sample seeds based on existing sample seeds for classification based applications. This approach uses existing sample seeds as keywords to search Web documents for collecting candidate new sample seeds for a specific class. However, this approach does not expand corpora for knowledge induction as well as any mechanism to detect a need for expansion of the corpus, to identify appropriate candidate corpora, and to further identify appropriate candidate documents in the candidate corpora.

Although conventional approaches have been developed in association with knowledge graphs and corpora, these conventional approaches utilize a relatively straightforward mechanism that does not consider whether a corpus requires expansion, determining which corpus requires expansion, determining documents or sources that are to be used in expansion of a candidate corpus, etc. from which a knowledge graph may induce knowledge based on a domain-specific corpus.

### SUMMARY

The exemplary embodiments disclose a method, a computer program product, and a computer system for inducing knowledge from a knowledge graph. The method comprises receiving a request, the request being indicative of a domain. The method comprises determining a corpus corresponding to the domain, the corpus including data related to the domain. The method comprises determining a quality of the corpus in generating the knowledge graph in which to induce knowledge relative to a quality threshold. As a result of the quality of the corpus not satisfying the quality threshold, the method comprises determining a candidate expansion corpus to incorporate further data therefrom into the corpus relative to an expansion threshold. As a result of the candidate expansion corpus satisfying the expansion threshold, the method comprises generating an expanded corpus by expanding the corpus with the further data. The method comprises generating the knowledge graph based on the expanded corpus from which the knowledge is induced. The method comprises generating a response to the request based on the knowledge graph.

In a preferred embodiment, the method further comprises determining candidate terms from the corpus, the candidate terms being selected based on the domain, an analysis of the request, or a combination thereof.

In a preferred embodiment, the method further comprises determining a corpus quality score for each of the candidate terms, the corpus quality score being indicative of a relation of the candidate terms across the corpus, wherein the quality threshold is a configurable percentage of the corpus quality scores satisfying a minimum threshold.

In a preferred embodiment, determining the candidate expansion corpus further comprises taking a sample of data from the candidate expansion corpus, calculating the corpus quality score for each of the candidate terms in the candidate expansion corpus, and determining whether the candidate expansion corpus satisfying the expansion threshold, the expansion threshold being indicative of a similarity metric between the corpus and the candidate expansion corpus.

In a preferred embodiment, generating the expanded corpus comprises determining a first set of data associated with a seed category in the candidate expansion corpus, determining a second set of data associated with a seed document in the candidate expansion corpus, and determining a third set of data associated with an interaction between the first and second sets.

In a preferred embodiment, generating the expanded corpus comprises extracting domain specific terminology from data of the corpus, scoring each of the domain specific terminology based on relation objects, ranking the domain specific terminology, selecting ones of the domain specific terminology based on the ranking, and determining the further data in the candidate expansion corpus based on the select ones of the domain specific terminology.

In a preferred embodiment, generating the expanded corpus is an automatic domain specific corpus creation, an entity lookup-based automatic domain specific corpus expansion using knowledge base relations, or a combination thereof.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary schematic diagram of a knowledge induction system 100, in accordance with the exemplary embodiments.

FIG. 2 depicts an exemplary flowchart of a method illustrating the operations of a knowledge server 130 of the knowledge induction system 100 in inducing knowledge from a knowledge graph, in accordance with the exemplary embodiments.

FIG. 3 depicts an exemplary block diagram depicting the hardware components of the knowledge induction system 100 of FIG. 1, in accordance with the exemplary embodiments.

FIG. 4 depicts a cloud computing environment, in accordance with the exemplary embodiments.

FIG. 5 depicts abstraction model layers, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

The exemplary embodiments are directed to a method, computer program product, and system for corpus expansion techniques that focus on documents with consideration of domain entities as well as additionally focusing on a strength of the relations among the entities. That is, the exemplary embodiments are configured to analyze the documents that contain text that may be used to facilitate extracting relations among the entities. Through an analysis of available corpora of documents, corpora may be selected to incorporate into a corpus from which a knowledge graph may be created. As will be described in greater detail herein, the exemplary embodiments may automatically induce knowledge from a corpus of domain specific documents by extracting candidate terms from an original corpus to determine if the original corpus requires expansion based on a corpus quality score of the candidate terms. From the available corpora, the exemplary embodiments may select and determine the available corpora to use for the knowledge inductions and then expanding the domain specific original corpus using the selected available corpora through expansion mechanisms. Key benefits of the exemplary embodiments may include a more comprehensive approach to knowledge induction to generate a knowledge graph having more meaningful connections between information by expanding a corpus that requires corpus expansion. Detailed implementation of the exemplary embodiments follows.

In utilizing a knowledge graph, the information from which the knowledge graph is based may define how well an application that utilizes the knowledge graph to generate responses, for example, to information requests. Knowledge induction in creating the knowledge graph may generate the artifacts needed by downstream applications with minimum manual effort (e.g., virtual assistants for information technology support). As the scale in which knowledge graphs increase, automatic knowledge induction processes become more essential for creating the knowledge graphs at scale. With data in the public domain changing at increasing rates (e.g., an information repository may experience 10 million new entries over a six month period), automatic knowledge induction may enable knowledge graphs to remain in sync with ever changing knowledge. Accordingly, the corpus from which a knowledge graph is created may be of paramount importance. The exemplary embodiments are therefore configured to measure a quality of an original corpus from which a knowledge graph may be created and expanding the original corpus using available corpora of documents to increase the quality of the original corpus when a minimum quality threshold is not satisfied. In this manner, the exemplary embodiments may avoid the original corpus not being of a sufficient quality for automatic knowledge induction operations.

The exemplary embodiments are described with regard to knowledge graphs and corpora associated with knowledge graphs. However, the exemplary embodiments may be utilized for any basis on which information may be interconnected and used for a variety of purposes such that a quality of the information meets a minimum standard from which to draw conclusions. Accordingly, the mechanisms provided by the exemplary embodiments may be utilized and/or modified for use in inducing information.

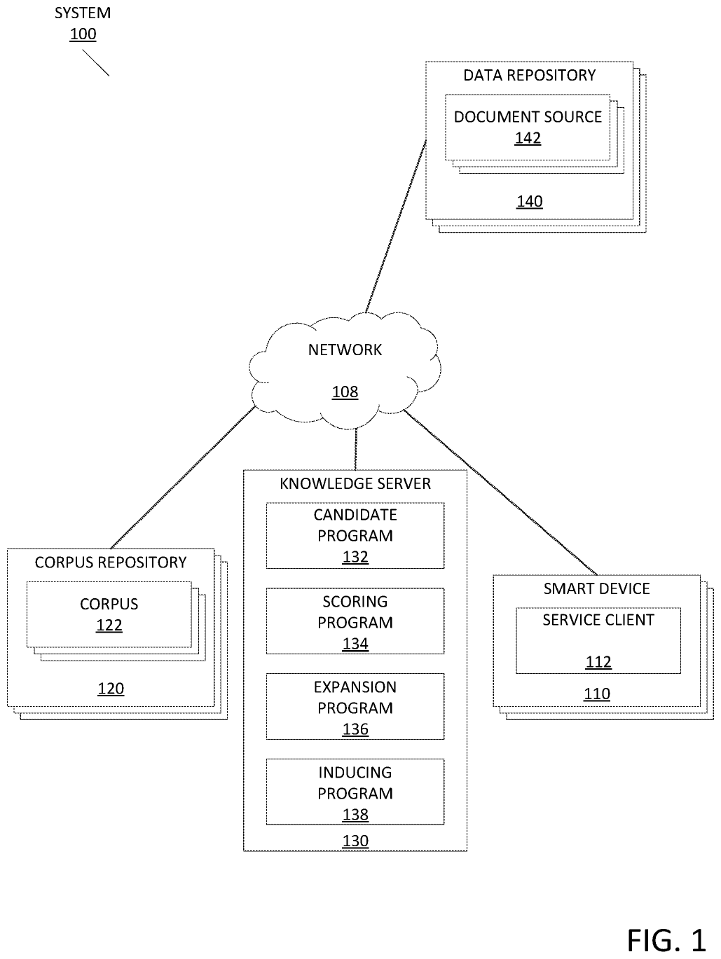

FIG. 1 depicts a knowledge induction system 100, in accordance with the exemplary embodiments. According to the exemplary embodiments, the knowledge induction system 100 may include one or more smart devices 110, one or more corpus repositories 120, a knowledge server 130, and one or more data repositories 140, which may all be interconnected via a network 108. While programming and data of the exemplary embodiments may be stored and accessed remotely across several servers via the network 108, programming and data of the exemplary embodiments may alternatively or additionally be stored locally on as few as one physical computing device or amongst other computing devices than those depicted.

In the exemplary embodiments, the network 108 may be a communication channel capable of transferring data between connected devices. Accordingly, the components of the knowledge induction system 100 may represent network components or network devices interconnected via the network 108. In the exemplary embodiments, the network 108 may be the Internet, representing a worldwide collection of networks and gateways to support communications between devices connected to the Internet. Moreover, the network 108 may utilize various types of connections such as wired, wireless, fiber optic, etc. which may be implemented as an intranet network, a local area network (LAN), a wide area network (WAN), or a combination thereof. In further embodiments, the network 108 may be a Bluetooth network, a WiFi network, or a combination thereof. In yet further embodiments, the network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices. For example, the network 108 may also represent direct or indirect wired or wireless connections between the components of the knowledge induction system 100 that do not utilize the network 108.

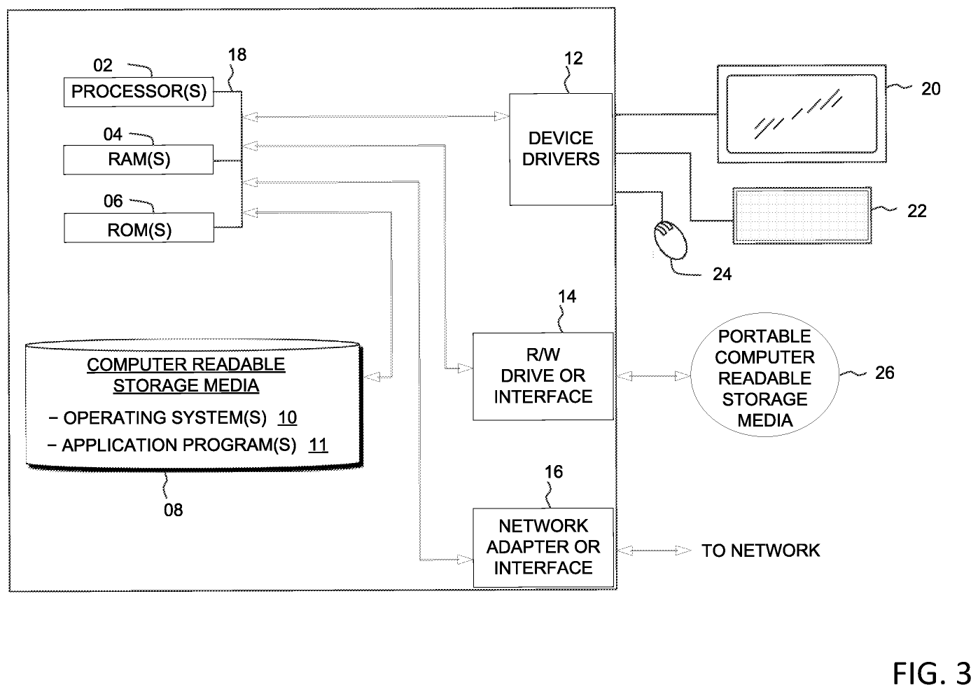

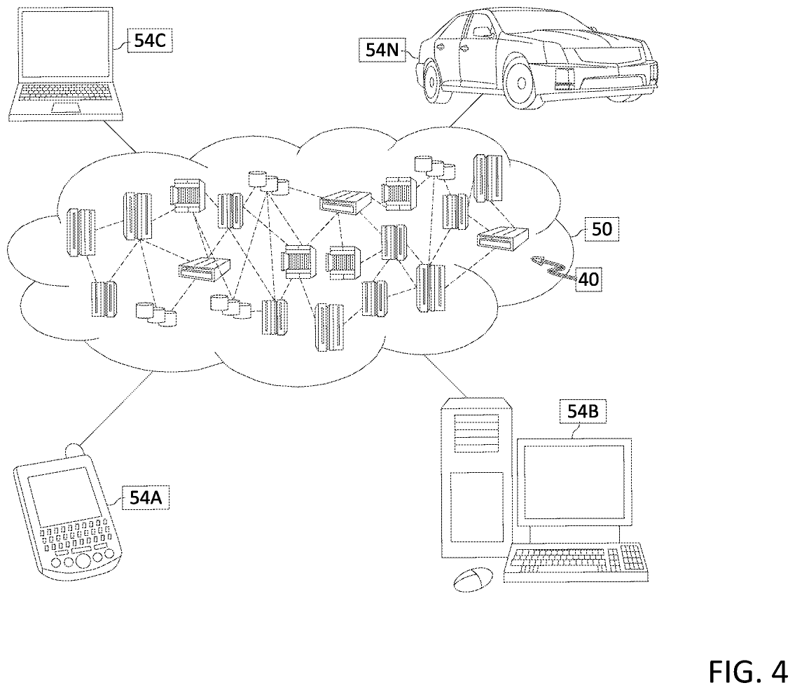

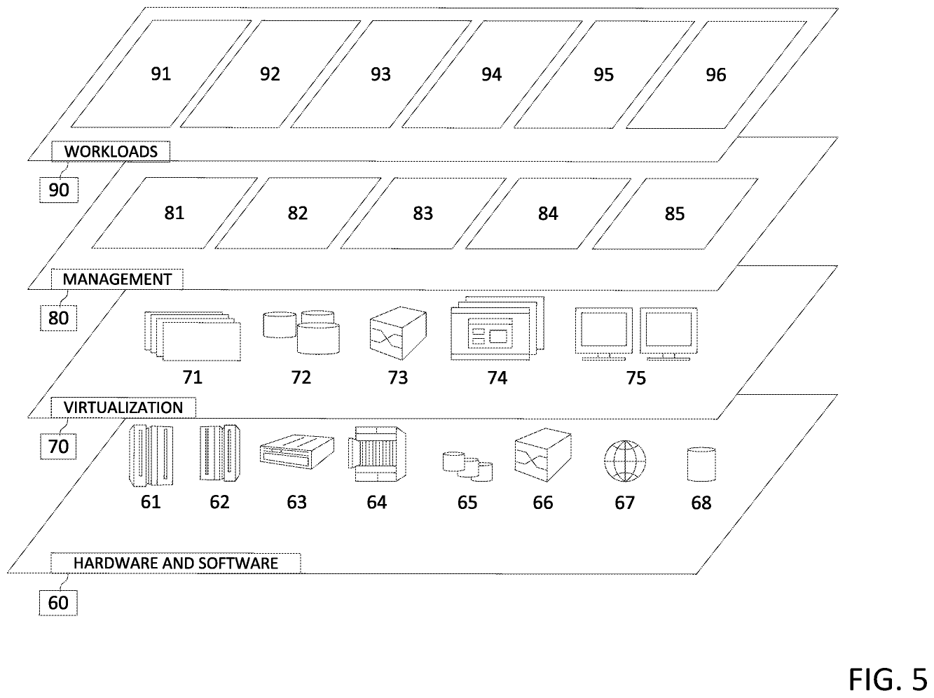

In the exemplary embodiments, the smart device 110 may include a service client 112 and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an Internet of Things (IoT) device, or any other electronic device or computing system capable of receiving and sending data to and from other computing devices. While the smart device 110 is shown as a single device, in other embodiments, the smart device 110 may be comprised of a cluster or plurality of computing devices, in a modular manner, etc., working together or working independently. The smart device 110 is described in greater detail as a hardware implementation with reference to FIG. 3, as part of a cloud implementation with reference to FIG. 4, and/or as utilizing functional abstraction layers for processing with reference to FIG. 5.

In the exemplary embodiments, the service client 112 may act as a client in a client-server relationship and may be a software, hardware, and/or firmware based application capable of allowing a user to request data and receive a response to the request via the network 108. In embodiments, the service client 112 may operate as a user interface allowing the user to submit a request for data and present the requested data to the user as well as interact with one or more components of the knowledge induction system 100, and utilize various wired and/or wireless connection protocols for data transmission and exchange associated with data that is determined based on fusion operations, including Bluetooth, 2.4 gHz and 5 gHz internet, near-field communication, Z-Wave, Zigbee, etc.

A user may require selected data for a variety of reasons and may utilize a service for which the selected data is requested. For example, the service client 112 may be a browser or application in which a search may be requested. The user may enter a search request in an available field and transmit the search request to a network component configured to return a response to the request. In generating the request, the other components of the knowledge induction system 100 (e.g., the knowledge server 130) may be utilized.

In the exemplary embodiments, the corpus repository 120 may include one or more corpora 122 and may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of storing, receiving, and sending data to and from other computing devices. While the corpus repository 120 is shown as a single device, in other embodiments, the corpus repository 120 may be comprised of a cluster or plurality of electronic devices, in a modular manner, etc., working together or working independently. While the corpus repository 120 is also shown as a separate component, in other embodiments, the corpus repository 120 may be incorporated with one or more of the other components of the knowledge induction system 100. For example, the corpus repository 120 may be incorporated in the knowledge server 130. Thus, access to the corpus repository 120 by the knowledge server 130 may be performed locally. The corpus repository 120 is described in greater detail as a hardware implementation with reference to FIG. 3, as part of a cloud implementation with reference to FIG. 4, and/or as utilizing functional abstraction layers for processing with reference to FIG. 5.

Each of the corpora 122 may be domain specific and utilized to create a knowledge graph from inducing knowledge therefrom that may be used in responding to the request. The corpora 122 may be a collection of data or information that are associated with a domain, a topic, etc. For example, the corpora 122 may be a set of documents that pertain to a given domain. Thus, for a given request, the appropriate corpus from the corpora 122 may be determined as an original corpus from which subsequent operations may be performed (e.g., to measure a quality of the original corpus to generate a knowledge graph that is used in responding to the request).

In the exemplary embodiments, the data repository 140 may include one or more document sources 142 and may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of storing, receiving, and sending data to and from other computing devices. While the data repository 140 is shown as a single device, in other embodiments, the data repository 140 may be comprised of a cluster or plurality of electronic devices, in a modular manner, etc., working together or working independently. While the data repository 140 is also shown as a separate component, in other embodiments, the data repository 140 may be incorporated with one or more of the other components of the knowledge induction system 100. For example, the data repository 140 may be incorporated in the knowledge server 130. Thus, access to the data repository 140 by the knowledge server 130 may be performed locally. The data repository 140 is described in greater detail as a hardware implementation with reference to FIG. 3, as part of a cloud implementation with reference to FIG. 4, and/or as utilizing functional abstraction layers for processing with reference to FIG. 5.

Each data repository 140 may represent a source from which documents for a variety of domains or topics may be available. For example, a first data repository 140 may be an online encyclopedia that includes data for a variety of different topics. In another example, a second data repository 140 may be an online medical resource that includes data for medically related topics. Each data repository 140 may hold a plurality of document sources 142 that represent individual documents from which to draw information related to the domain in which the data repository 140 is directed.

In the exemplary embodiments, the knowledge server 130 may include a candidate program 132, a scoring program 134, an expansion program 136, and an inducing program 138, and act as a server in a client-server relationship with the service client 112 as well as be in a communicative relationship with the corpus repository 120 and the data repository 140. The knowledge server 130 may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of receiving and sending data to and from other computing devices. While the knowledge server 130 is shown as a single device, in other embodiments, the knowledge server 130 may be comprised of a cluster or plurality of computing devices, working together or working independently. While the knowledge server 130 is also shown as a separate component, in other embodiments, the operations and features of the knowledge server 130 may be incorporated with one or more of the other components of the knowledge induction system 100. For example, the operations and features of the knowledge server 130 may be incorporated in the smart device 110, particularly the smart device 110 of the user who is requesting the data. The knowledge server 130 is described in greater detail as a hardware implementation with reference to FIG. 3, as part of a cloud implementation with reference to FIG. 4, and/or as utilizing functional abstraction layers for processing with reference to FIG. 5.

The knowledge server 130 is configured to, in response to a request for data, generate a response using a knowledge graph that is created based on one of the corpora 122 associated with a topic of the request. In creating the knowledge graph, the knowledge server 130 may determine a quality of the corpus 122 and determine whether the corpus 122 has a sufficient quality (e.g., satisfying a minimum threshold as will be described in detail below). As a result of the corpus 122 having a sufficient quality, the knowledge server 130 may generate the knowledge graph and generate the response using the knowledge graph. However, as a result of the corpus 122 having an insufficient quality, the knowledge server 130 may expand the corpus 122 into a modified form of the corpus 122 that includes information from the data repositories 140. In expanding the corpus 122, the knowledge server 130 may determine which of the data repositories 140 and/or the document sources 142 therein to use to expand the corpus 122 in a meaningful manner. Using the corpus 122 (e.g., in the original form or in the modified form), the knowledge server 130 may generate the knowledge graph and induce knowledge therefrom to generate the response for the request.

The exemplary embodiments are described with regard to receiving a request for data and generating a response for the request where the response is generated based on a knowledge graph from a corpus 122 having a sufficient quality (e.g., in the original form or the modified form where the original form is expanded). However, the exemplary embodiments being utilized as a request and response format where the knowledge graph is generated for the request is only exemplary. The knowledge server 130 may be configured to determine a quality of the corpora 122 for various domains at a variety of other times and generate corresponding knowledge graphs. For example, in preparation to provide a response, the knowledge server 130 may associate the corpora 122 to various domains and topics and determine a quality of the corpora 122 for a selected domain. Based on a result of the quality determination, the knowledge server 130 may preliminarily expand the corpora 122 when a quality does not meet a minimum threshold for a given domain. Accordingly, when a request is subsequently received for the given domain, the knowledge server 130 may have already determined that the corpora 122 meets the minimum threshold (e.g., the corpora 122 in its original form meets the minimum threshold or the corpora 122 has been expanded to meet the minimum threshold). Accordingly, the knowledge server 130 may reduce processing requirements and proceed with generating the knowledge graph and induce knowledge therefrom in generating the response.

In the exemplary embodiments, the candidate program 132 may be a software, hardware, and/or firmware application configured to determine candidates used in determining a corpus 122 to be used for the knowledge graph. For example, the candidate program 132 may be configured to determine a candidate corpus 122 for which subsequent operations may be performed. In determining the candidate corpus 122, the candidate program 132 may analyze the request and identify one or more corpora 122 that may be utilized in creating the appropriate knowledge graph. For example, the request may be parsed to determine keywords. The corpora 122 may be associated with keywords such that corpora 122 having matching keywords to the keywords of the request are identified as candidate corpora 122. Once the candidate corpora 122 are determined, the knowledge server 130 may perform subsequent operations.

The candidate program 132 may also be configured to extract candidate terms from a selected corpus 122 to be used in creating the knowledge graph for the response. The candidate terms may be selected based on the request to determine whether the candidate terms in the corpus 122 are representative of a quality of the corpus 122. For example, based on a parsing of the request, one of the corpora 122 may be selected (e.g., each corpus 122 may be associated with certain keywords where the request including these keywords may be indicative of utilizing the corpus 122). The request may also be indicative of select portions of the corpus 122 that is to be considered to meaningfully generate the response. The select portions may be associated with terms from which the candidate program 132 may determine the candidate terms.

In the exemplary embodiments, the scoring program 134 may be a software, hardware, and/or firmware application configured to determine a corpus quality score for each of the candidate terms. An overall analysis of the corpus quality scores of the candidate terms may be used to determine whether the corpus 122 requires expansion to meet the minimum threshold for quality. As will be described in further detail below, the corpus quality score may be determined based on a relation type across the selected corpus 122 and/or based on terms and relations across the selected corpus 122. The corpus quality scores on an individual basis and/or a holistic basis may be used by the scoring program 134 to determine whether the corpus 122 in its original form meets the minimum threshold for quality or whether the corpus 122 requires expansion into a modified form to meet the minimum threshold.

In the exemplary embodiments, the expansion program 136 may be a software, hardware, and/or firmware application configured to expand the corpus 122 as a result of determining that the selected corpus 122 does not meet the minimum threshold for quality in its original form. In expanding the selected corpus 122, the expansion program 136 may determine the data repositories 140 to use for the expansion. As will be described in further detail below, the expansion program 136 may take a sample of the document sources 142 and calculate a corpus quality score for the candidate terms in the data repository 140. Based on the corpus quality score, the expansion program 136 may select the data repository 140 when a cross-document reference ratio meets a selection threshold.

The expansion program 136 may further be configured to expand the selected corpus 122 utilizing an expansion mechanism. As will be described in further detail below, the expansion program 136 may expand the selected corpus 122 using an automatic corpus expansion process. For example, the expansion program 136 may select seed documents among the document sources 142 of the data repository 140. The expansion program 136 may determine a first set of documents associated with a seed category and descendant sub-categories up to a first depth and a second set of documents from a seed document and associated documents up to a second depth. The expansion program 136 may determine a third set as an interaction of the first and second set of documents to output documents corresponding to the third set which are used for the expansion. In another example, the expansion program 136 may utilize all documents of the selected corpus 122 in its original form. The expansion program 136 may process the documents of the selected corpus 122 and extract domain terminology in a manner substantially similar to determining the candidate terms. The expansion program 136 may perform a search (e.g., a text search( ) on each terminology and collect the top results up to a selected limit. The expansion program 136 may determine relation objects in each entity and count select ones that match with terms in the domain terminology from which a score may be assigned. After all searches, the expansion program 136 may calculate a cumulative score of each entity and rank the entities from which the top entities from the ranked list are used as a basis to expand the selected corpus 122.

In the exemplary embodiments, the inducing program 138 may be a software, hardware, and/or firmware application configured to induce knowledge from the knowledge graph that is created based on the corpus 122 that is to be used. For example, the corpus 122 may be in its original form as a result of the quality meeting the minimum threshold. In another example, the corpus 122 may be in a modified form as a result of expanding the corpus 122 to meet the minimum threshold. The corpus 122 in its original form or the modified form may be used to create the knowledge graph from which the inducing program 138 may induce knowledge using any mechanism as would be understood by one skilled in the art. The knowledge server 130 may subsequently generate a response to the request using the available information including direct information and induced information.

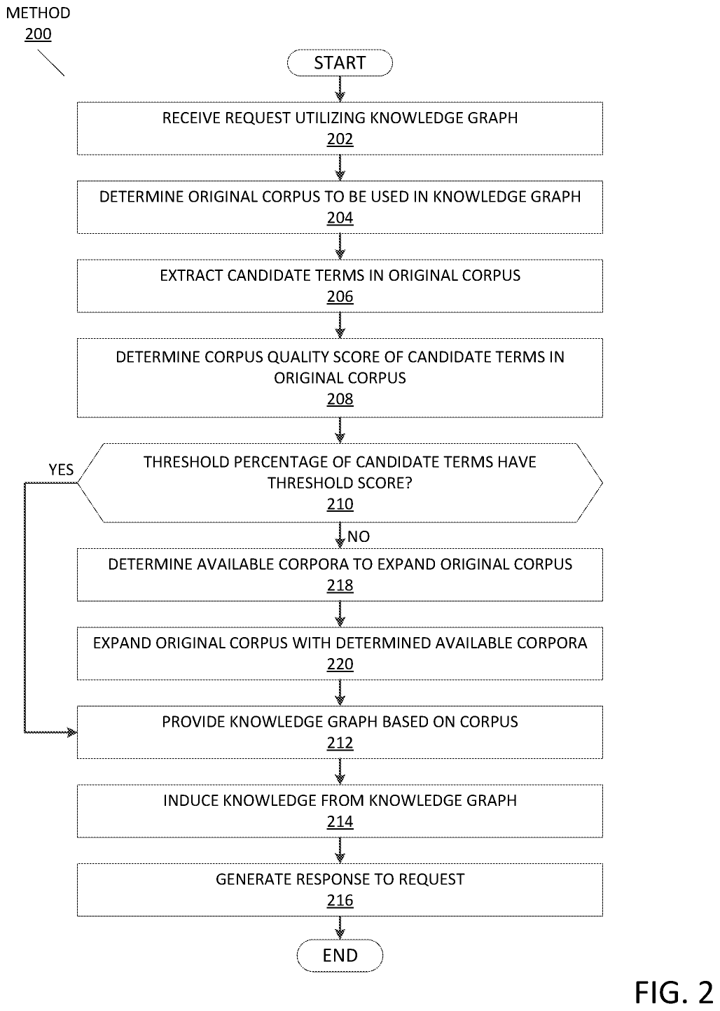

FIG. 2 depicts an exemplary flowchart of a method 200 illustrating the operations of the knowledge server 130 of the knowledge induction system 100 in in inducing knowledge from a knowledge graph, in accordance with the exemplary embodiments. The method 200 may relate to operations that are performed by the candidate program 132, the scoring program 134, the expansion program 136, and the inducing program 138 to determine a corpus 122 to be used in creating the knowledge graph and inducing knowledge therefrom. The method 200 will be described from the perspective of the knowledge server 130.

The knowledge server 130 may receive a request that utilizes a knowledge graph to generate the response (step 202). As described above, a user utilizing the smart device 110 may use the service client 112 to enter a request for data. For example, the service client 112 may be a browser, a proprietary application, etc. in which the user may enter a request in a field. The request may be a string of characters including one or more words as a phrase, a sentence, a question, etc. In a specific implementation, the user may enter a request to receive information for an individual. The request may further request an event that occurred for the individual (e.g., “When did individual X discover event Y?”). The service client 112 may package the request and transmit the request to the knowledge server 130.

The knowledge server 130 may determine one of the corpora 122 to be used for the knowledge graph in its original form (step 204). For example, the candidate program 132 may determine one or more candidate corpora 122 to be used in creating the knowledge graph based on keyword matching where keywords extracted from the request are matched to keywords respectively associated with the corpora 122.

The knowledge server 130 may extract candidate terms from the determined corpus 122 in its original form (step 206). For example, the candidate program 132 may extract the candidate terms from a select one of the candidate corpora 122. The candidate terms that are extracted may be representative of determining a quality of the candidate corpora 122 in creating the knowledge graph in generating the response. For example, the corpora 122 may include a plurality of documents with a wide range of different types of information. The candidate terms may be selected based on the request and extracted in the corpus 122. Those skilled in the art will understand the various different techniques that may be utilized to determine the candidate terms and extracting those candidate terms in the corpus 122. For example, when the request relates to when an individual had an event occur, the candidate terms may include the individual's name, an identity of the event, etc. Such candidate terms may be direct candidate terms derived directly from the request. The candidate program 132 may also elaborate to select and extract indirect candidate terms based on the direct candidate terms. For example, the individual's name may be associated with further individuals who were involved in the selected event. The selected event may be associated with further events that may have occurred prior to, concurrent with, and subsequent to the event indicated in the request. Other techniques such as distributional similarity and word vectors may be used to further select indirect candidate terms.

The knowledge server 130 may determine a corpus quality score of the candidate terms in the determined corpus 122 in its original form (step 208). The objective of the corpus quality score is to have an indicative measure on how good the corpus is for inducing a knowledge graph from it or if it needs further expansion. For example, the scoring program 134 may be configured to determine the corpus quality scores. In determining the corpus quality scores, the knowledge server 130 may determine whether the selected corpus 122 requires expansion to create the knowledge graph. That is, the knowledge server 130 may determine a quality of the corpus 122 in creating the knowledge graph.

The knowledge server 130 may perform an initial knowledge induction on the corpus 122 in its original form through determining the corpus quality scores of the candidate terms. The knowledge server 130 may utilize a variety of variables in determining the corpus quality scores. For example, the inputs to determine the corpus quality scores may include a number N of terms that are extracted (e.g., the number of candidate terms) and all the relation instances that are extracted, R, which consists of k subsets, each subset corresponding to a given relation type.

The knowledge server 130 may be configured to utilize different mechanisms in calculating the corpus quality scores. For example, the knowledge server 130 may utilize a mechanism based on relation types across the corpus 122. In this mechanism, the knowledge server 130 may consider R consists of k subsets where each subset corresponds to a given relation type. In this manner, the knowledge server 130 may calculate the corpus quality score as a ratio between size of the R and of N by N. For example, for each relation type Rᵢ, the knowledge server 130 may compute sᵢ=|Rᵢ|/(N×N). The knowledge server 130 may also set a configurable as the percentage of relation types out of all relation types that are lower than a minimum threshold for the corpus quality score to satisfy. For example, an administrator of the knowledge server 130 may set the configurable percentage. The configurable percentage may indicate a relative strength of quality of the relations in the corpus 122. Accordingly, when the relation types Ri do not meet the configurable percentage, the knowledge server 130 may conclude that the corpus expansion on the corpus 122 in its original form is required. That is, as a result of the configurable percentage of relation types Rᵢ having a low score sᵢ that is below the minimum threshold, the knowledge server 130 may indicate that the knowledge server 130 is to expand the corpus 122 in its original form using subsequent operations.

In another example, the knowledge server 130 may utilize a mechanism based on terms and relations across the corpus 122. In this mechanism, the knowledge server 130 may again refer to the variable inputs N and R. According to this mechanism, for each term tin the terminology (e.g., the candidate terms), the knowledge server 130 may determine a number of relation instances that each term t participates. In calculating the corpus quality scores, the knowledge server 130 may determine a ratio between all relations that a term t is part of relative to R. For example, for each term t, the knowledge server 130 may compute s=|all relations that t is a part|/|R|. In a substantially similar manner as the other mechanism described above, the knowledge server 130 may set a configurable percentage as a minimum threshold for the corpus quality score to satisfy. When the terms t do not meet the configurable percentage, the knowledge server 130 may conclude that the corpus expansion on the corpus 122 in its original form is required.

In computing the corpus quality score, the knowledge server 130 may create ground truth data from reference documents having the same domain. The knowledge server 130 may use the ground truth data for comparison purposes to determine how the corpus quality scores may satisfy the minimum threshold.

The knowledge server 130 may output the corpus quality scores and the overall determination of whether the corpus 122 in its original form requires expansion. In the manner described above, the knowledge server 130 may thereby set the threshold for triggering the corpus expansion based on user defined parameters (e.g., the configurable percentage), learned information from previous satisfactory corpora, or a combination thereof.

The knowledge server 130 may determine whether a threshold percentage of the candidate terms have a threshold score (decision 210). As a result of the threshold percentage of the candidate terms having the threshold score (decision 210, “YES” branch), the knowledge server 130 may generate the knowledge graph using the determined corpus 122 in its original form (step 212). The knowledge server 130 may induce knowledge from the knowledge graph (step 214) and generate the response to the request based on the available knowledge (step 216). For example, the inducing program 138 may induce knowledge from the knowledge graph that has been created.

As a result of the threshold percentage of the candidate terms not having the threshold score (decision 210, “NO” branch), the knowledge server 130 may determine the available corpora to expand the determined corpus 122 (step 218). For example, the expansion program 136 may determine the manner in which to perform the corpus expansion. In an aspect of determining the manner in which to perform the corpus expansion, the knowledge server 130 may determine select corpora from the data repositories 140 in which to perform the corpus expansion in a meaningful way. The knowledge server 130 may input the determined corpus 122 that has been determined to require corpus expansion. The knowledge server 130 may also analyze available candidate expansion corpora among the data repositories 140. As described above, the data repositories 140 may include open domain sources, specific domain sources, etc. In a particular implementation, the documents in the expansion corpus that is to be used in the corpus expansion may be interlinked.

In selecting the corpora of the data repositories 140 for the corpus expansion, the knowledge server 130 may obtain domain specific terminology from the target corpus in the data repositories 140. The knowledge server 130 may utilize any available tool for terminology extraction. For example, the knowledge server 130 may use a domain specific terminology extraction mechanism by boosting frequency metrics. In another example, the knowledge server 130 may use an automatic extraction of domain specific terminology from a large corpus. The terminology extracted in this manner for the corpus expansion will be referred hereinafter as “domain terminology”.

The knowledge server 130 may select the corpora in the data repositories 140 by considering each candidate expansion corpus. For each candidate expansion corpus, the knowledge server 130 may take a sample of the documents in the document sources 142 of a selected one of the data repositories 140 that is a candidate. The sample of the documents may be random or predetermined to properly represent the candidate data repository 140. The knowledge server 130 may determine the corpus quality score for the same candidate terms used in the determined corpus 122 using a substantially similar process as the corpus quality score determination described above. Based on the configurable percentage of candidate terms satisfying the minimum score threshold, the knowledge server 130 may determine whether the candidate expansion corpus is an appropriate candidate to use in the corpus expansion. For example, if the corpus quality scores fall below the configurable percentage (e.g., for the first mechanism described above), the knowledge server 130 may skip this candidate expansion corpus. In computing the corpus quality scores for the candidate expansion corpus, the knowledge server 130 may ignore the domain. The knowledge server 130 may also determine a cross-document reference (e.g., interlinks) ratio among the documents in the sample. If the ratio is smaller than a predetermined threshold (e.g., the configurable percentage for the second mechanism described above), the knowledge server 130 may skip the candidate expansion corpus. The knowledge server 130 may then run terminology extraction on the sample. The terminology extracted at this stage will be referred hereinafter as the “expansion corpus terminology”. The knowledge server 130 may determine a semantic and/or topic similarity between the terminology of the determined corpus 122 and the expansion corpus terminology. In setting an expansion threshold for the similarity in terminologies, the knowledge server 130 may determine whether the candidate expansion corpus satisfies the expansion threshold for selection in the corpus expansion of the determined corpus 122.

The knowledge server 130 may expand the determined corpus 122 in its original form to a modified form (step 220). For example, the expansion program 136 may be configured to perform the corpus expansion using the candidate expansion corpus determined previously. In performing the corpus expansion, the knowledge server 130 may utilize an automatic corpus expansion based on a variety of mechanisms. As will be described below, according to an exemplary mechanism, the knowledge server 130 may perform an automatic domain specific corpus creation from the candidate expansion corpus with minimal input. According to a further exemplary mechanism, the knowledge server 130 may perform an entity lookup-based automatic domain specific corpus expansion using knowledge base relations.

According to the first mechanism in which the knowledge server 130 performs an automatic domain specific corpus creation from the candidate expansion corpus, the knowledge server 130 may utilize inputs including one or more representative seed documents for the domain (e.g., a specific document in the document source 142 of the data repository 140) and one or more seed categories of the domain (e.g., a higher level or general category of the domain). Categories may be any high level organization of documents into subsets of smaller document collections. In performing the corpus expansion, the knowledge server 130 may normalize the documents of the expansion corpus if this process is required. For example, seed documents from a first data repository 140 may be normalized to a second data repository 140. Those skilled in the art will understand that there are a variety of different manners of normalizing the documents such as utilizing a linking tool. The knowledge server 130 may determine a first set of article links that are associated with a seed category and descendent sub-categories up to a first depth n. The knowledge server 130 may determine a second set of document links from a seed document and then from further documents linked to the seed document and linked documents up to a second depth m. The depths n and m may be specified, for example, by a user such as an administrator of the knowledge server 130. The greater the values of n and/or m corresponds to a larger domain specific corpus and may require more time to detect and fetch the respective documents and/or links. The knowledge server 130 may determine a third set of documents as an interaction between the first and second sets. The knowledge server 130 may then output documents corresponding to the links established in the third set of documents.

According to the second mechanism in which the knowledge server 130 performs an entity lookup-based automatic domain specific corpus expansion using knowledge base relations, the knowledge server 130 may utilize inputs including the documents of the determined corpus 122. In performing the corpus expansion, the knowledge server 130 may process the documents of the determined corpus 122 and extract the domain terminology as described above. The knowledge server 130 may perform a text search on each extract phrase and collect the top results r where the search term is greater than the ranked list of r entities. The knowledge server 130 may determine the relation objects in each entity and count those that match with terms in the domain terminology where the relations establish relations rd. The knowledge server 130 may assigned each search result with a score where the score is based on the relations rd and a similarity. For example, the knowledge server 130 may compute the score as rd+(string similarity (phrase, entity label)*1/rank). After all the searches, the knowledge server 130 may determine a cumulative score of each entity appearing in the results and rank the entities based on the cumulative score. The knowledge server 130 may then select the top s entities from the ranked list. The values of r and s may be specified, for example, by a user such as the administrator of the knowledge server 130. When r is smaller, only the top search results may be considered. The value of s may determine a size of the expanded corpus. The knowledge server 130 may utilize a query service to get corresponding documents in the data repository 140 for each entity in the list.

Through one or more of the above mechanisms, the knowledge server 130 may perform the corpus expansion by expanding the determined corpus 122 in its original form with the determined documents satisfying a threshold to expand the determined corpus 122 in a meaningful manner. Accordingly, in performing the corpus expansion, the knowledge server 130 may generate a modified corpus 122 which is an expanded form of the determined corpus 122.

The knowledge server 130 may then generate the knowledge graph using the modified corpus 122 in a modified form relative to the original form (step 212). The knowledge server 130 may induce knowledge from the knowledge graph (step 214) and generate the response to the request based on the available knowledge (step 216). For example, the inducing program 138 may induce knowledge from the knowledge graph that has been created.

The method 200 may include additional iterations of the above operations when more than one candidate corpus 122 is determined for use in generating the response. For example, a request for data may combine generally disparate domains. In such a request, the knowledge server 130 may require corresponding corpora 122 that are associated with each of the different domains. For each corpora 122 that is determined to be used, the knowledge server 130 may perform the above operations for information used to generate the response by determining a quality of each corpus 122 and expanding those corpus 122 that do not meet the minimum threshold for quality.

Through iterations of the method 200, the corpora 122 may be expanded such that subsequent uses of any of the corpora 122 may not require expansion for the knowledge graph to induce knowledge therefrom. Accordingly, in an exemplary implementation, for a given application or type of query, the method 200 may be a one-time process and may not be required for each user query. In this manner, the method 200 may be performed as a pre-processing step before knowledge induction.

The exemplary embodiments are configured to determine whether a knowledge graph may be created based on a quality determination of a base corpus used to create the knowledge graph. The exemplary embodiments may perform an initial determination as to a quality of the base corpus. The base corpus having a minimum threshold quality may be used to generate the knowledge graph. However, the base corpus not satisfying the minimum threshold quality may require corpus expansion. The exemplary embodiments may perform the corpus expansion by selecting appropriate expansion corpora that expands the base corpus in a meaningful manner. Upon determining the appropriate expansion corpora, the exemplary embodiments may expand the base corpus using an automatic corpus expansion mechanism. Upon expanding the base corpus, the exemplary embodiments may generate the knowledge graph using the expanded corpus from which knowledge may be induced. Based on the knowledge graph and the induced knowledge, the exemplary embodiments may handle requests for data using this data.

FIG. 3 depicts a block diagram of devices within the knowledge induction system 100 of FIG. 1, in accordance with the exemplary embodiments. It should be appreciated that FIG. 3 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 40 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and the exemplary embodiments are not limited thereto. As depicted, the following layers and corresponding functions are provided:

Hardware and software layer 60 include hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and knowledge induction processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for inducing knowledge from a knowledge graph, the method comprising:
receiving a request, the request being indicative of a domain;
determining a corpus corresponding to the domain, the corpus including data related to the domain;
determining a quality of the corpus in generating the knowledge graph in which to induce knowledge relative to a quality threshold;
as a result of the quality of the corpus not satisfying the quality threshold, determining a candidate expansion corpus to incorporate further data therefrom into the corpus relative to an expansion threshold;
as a result of the candidate expansion corpus satisfying the expansion threshold, generating an expanded corpus by expanding the corpus with the further data;
generating the knowledge graph based on the expanded corpus from which the knowledge is induced; and
generating a response to the request based on the knowledge graph.

2. The computer-implemented method of claim 1, further comprising:
determining candidate terms from the corpus, the candidate terms being selected based on the domain, an analysis of the request, or a combination thereof.

3. The computer-implemented method of claim 2, further comprising:
determining a corpus quality score for each of the candidate terms, the corpus quality score being indicative of a relation of the candidate terms across the corpus,
wherein the quality threshold is a configurable percentage of the corpus quality scores satisfying a minimum threshold.

4. The computer-implemented method of claim 3, wherein determining the candidate expansion corpus comprises:
taking a sample of data from the candidate expansion corpus;
calculating the corpus quality score for each of the candidate terms in the candidate expansion corpus; and
determining whether the candidate expansion corpus satisfying the expansion threshold, the expansion threshold being indicative of a similarity metric between the corpus and the candidate expansion corpus.

5. The computer-implemented method of claim 1, wherein generating the expanded corpus comprises:
determining a first set of data associated with a seed category in the candidate expansion corpus;
determining a second set of data associated with a seed document in the candidate expansion corpus; and
determining a third set of data associated with an interaction between the first and second sets.

6. The computer-implemented method of claim 1, wherein generating the expanded corpus comprises:
extracting domain specific terminology from data of the corpus;
scoring each of the domain specific terminology based on relation objects;
ranking the domain specific terminology;
selecting ones of the domain specific terminology based on the ranking; and
determining the further data in the candidate expansion corpus based on the select ones of the domain specific terminology.

7. The computer-implemented method of claim 1, wherein generating the expanded corpus is an automatic domain specific corpus creation, an entity lookup-based automatic domain specific corpus expansion using knowledge base relations, or a combination thereof.

8. A computer program product for inducing knowledge from a knowledge graph, the computer program product comprising:
one or more non-transitory computer-readable storage media and program instructions stored on the one or more non-transitory computer-readable storage media capable of performing a method, the method comprising:
receiving a request, the request being indicative of a domain;
determining a corpus corresponding to the domain, the corpus including data related to the domain;
determining a quality of the corpus in generating the knowledge graph in which to induce knowledge relative to a quality threshold;
as a result of the quality of the corpus not satisfying the quality threshold, determining a candidate expansion corpus to incorporate further data therefrom into the corpus relative to an expansion threshold;
as a result of the candidate expansion corpus satisfying the expansion threshold, generating an expanded corpus by expanding the corpus with the further data;
generating the knowledge graph based on the expanded corpus from which the knowledge is induced; and
generating a response to the request based on the knowledge graph.

9. The computer program product of claim 8, wherein the method further comprises:
determining candidate terms from the corpus, the candidate terms being selected based on the domain, an analysis of the request, or a combination thereof.

10. The computer program product of claim 9, wherein the method further comprises:
determining a corpus quality score for each of the candidate terms, the corpus quality score being indicative of a relation of the candidate terms across the corpus,
wherein the quality threshold is a configurable percentage of the corpus quality scores satisfying a minimum threshold.

11. The computer program product of claim 10, wherein determining the candidate expansion corpus comprises:
taking a sample of data from the candidate expansion corpus;
calculating the corpus quality score for each of the candidate terms in the candidate expansion corpus; and
determining whether the candidate expansion corpus satisfying the expansion threshold, the expansion threshold being indicative of a similarity metric between the corpus and the candidate expansion corpus.

12. The computer program product of claim 8, wherein generating the expanded corpus comprises:
determining a first set of data associated with a seed category in the candidate expansion corpus;
determining a second set of data associated with a seed document in the candidate expansion corpus; and
determining a third set of data associated with an interaction between the first and second sets.

13. The computer program product of claim 8, wherein generating the expanded corpus comprises:
extracting domain specific terminology from data of the corpus;
scoring each of the domain specific terminology based on relation objects;
ranking the domain specific terminology;
selecting ones of the domain specific terminology based on the ranking; and
determining the further data in the candidate expansion corpus based on the select ones of the domain specific terminology.

14. The computer program product of claim 8, wherein generating the expanded corpus is an automatic domain specific corpus creation, an entity lookup-based automatic domain specific corpus expansion using knowledge base relations, or a combination thereof.

15. A computer system for inducing knowledge from a knowledge graph, the computer system comprising:
one or more computer processors, one or more computer-readable storage media, and program instructions stored on the one or more of the computer-readable storage media for execution by at least one of the one or more processors capable of performing a method, the method comprising:
receiving a request, the request being indicative of a domain;
determining a corpus corresponding to the domain, the corpus including data related to the domain;
determining a quality of the corpus in generating the knowledge graph in which to induce knowledge relative to a quality threshold;
as a result of the quality of the corpus not satisfying the quality threshold, determining a candidate expansion corpus to incorporate further data therefrom into the corpus relative to an expansion threshold;
as a result of the candidate expansion corpus satisfying the expansion threshold, generating an expanded corpus by expanding the corpus with the further data;
generating the knowledge graph based on the expanded corpus from which the knowledge is induced; and
generating a response to the request based on the knowledge graph.

16. The computer system of claim 15, wherein the method further comprises:
determining candidate terms from the corpus, the candidate terms being selected based on the domain, an analysis of the request, or a combination thereof.

17. The computer system of claim 16, wherein the method further comprises:
determining a corpus quality score for each of the candidate terms, the corpus quality score being indicative of a relation of the candidate terms across the corpus,
wherein the quality threshold is a configurable percentage of the corpus quality scores satisfying a minimum threshold.

18. The computer system of claim 17, wherein determining the candidate expansion corpus comprises:
taking a sample of data from the candidate expansion corpus;
calculating the corpus quality score for each of the candidate terms in the candidate expansion corpus; and
determining whether the candidate expansion corpus satisfying the expansion threshold, the expansion threshold being indicative of a similarity metric between the corpus and the candidate expansion corpus.

19. The computer system of claim 15, wherein generating the expanded corpus comprises:
determining a first set of data associated with a seed category in the candidate expansion corpus;
determining a second set of data associated with a seed document in the candidate expansion corpus; and
determining a third set of data associated with an interaction between the first and second sets.

20. The computer system of claim 15, wherein generating the expanded corpus comprises:
extracting domain specific terminology from data of the corpus;
scoring each of the domain specific terminology based on relation objects;
ranking the domain specific terminology;
selecting ones of the domain specific terminology based on the ranking; and
determining the further data in the candidate expansion corpus based on the select ones of the domain specific terminology.
